(19) United States
(12) Patent Application Publication
(10) Pub. No.: US 2023/0379754 A1
(43) Pub. Date: Nov. 23, 2023

(54) AD-HOC RADIO BEARER AND INLINE SIGNALLING VIA REFLECTIVE QUALITY OF SERVICE

(71) Applicant: Apple Inc., Cupertino, CA (US)

(72) Inventors: Christian Hofmann, Muenchen (DE); Panagiotis Botsinis, Munich (DE); Sameh M. Eldessoki, Munich (DE); Tarik Tabet, San Jose, CA (US)

(73) Assignee: Apple Inc., Cupertino, CA (US)

(21) Appl. No.: 18/320,483

(22) Filed: May 19, 2023

Related U.S. Application Data
(60) Provisional application No. 63/344,993, filed on May 23, 2022.

(51) Int. Cl. H04W 28/02

(52) U.S. Cl. CPC H04W 28/0273; H04W 28/0268

(57) ABSTRACT

The present application relates to devices and components including apparatus, systems, and methods for ad-hoc radio bearer and inline signalling via reflective quality of service and reflective quality of service approaches.

### CROSS-REFERENCE TO RELATED APPLICATIONS

This application claims priority to U.S. provisional application No. 63/344,993, entitled “Ad-hoc Radio Bearer and Inline Signalling via Reflective Quality of Service,” filed on May 23, 2022, the disclosure of which is incorporated by reference herein in its entirety for all purposes.

### TECHNICAL FIELD

The present application relates to the field of wireless technologies and, in particular, to ad-hoc radio bearer and inline signalling via reflective quality of service and reflective quality of service approaches.

### BACKGROUND

Third Generation Partnership Project (3GPP) networks provide for communication of data between user equipment and network elements (such as base stations). The data is transported by data radio bearers between the user equipment and network elements. Generally, the data radio bearers are configured with a certain configuration and change of the configuration is avoided during operation due to challenges, such as latency.

### BRIEF DESCRIPTION OF THE DRAWINGS

FIG. 1 illustrates an example signal diagram of a radio bearer (RB) reconfiguration in accordance with some embodiments.

FIG. 2 illustrates an example uplink (UL) service data adaptation protocol (SDAP) data protocol data unit (PDU) in accordance with some embodiments.

FIG. 3 illustrates an example UL SDAP data PDU in accordance with some embodiments.

FIG. 4 illustrates an example signal diagram in accordance with some embodiments.

FIG. 5 illustrates an example UL SDAP data PDU in accordance with some embodiments.

FIG. 6 illustrates an example UL SDAP data PDU in accordance with some embodiments.

FIG. 7 illustrates an example signal diagram 700 in accordance with some embodiments.

FIG. 8 illustrates an example quality of service (QoS) flow prior to reconfiguration based on a UL SDAP data PDU in accordance with some embodiments.

FIG. 9 illustrates an example QoS flow after reconfiguration based on a UL SDAP data PDU in accordance with some embodiments.

FIG. 10 illustrates an example procedure for implementing UL reflective QoS in accordance with some embodiments.

FIG. 11 illustrates an example procedure for implementing UL reflective QoS in accordance with some embodiments.

FIG. 12 illustrates an example procedure for implementing UL reflective QoS in accordance with some embodiments.

FIG. 13 illustrates an example procedure for implementing UL reflective QoS in accordance with some embodiments.

FIG. 14 illustrates an example user equipment (UE) in accordance with some embodiments.

FIG. 15 illustrates an example next generation nodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “base station” may refer to nodeBs. For example, “base station” may refer to a nodeB, an evolved nodeB (eNB), and/or a next generation nodeB (gNB).

In legacy Third Generation Partnership Project (3GPP) networks, data is exchanged between user equipments (UEs) and base stations using radio bearers. The legacy radio bearers generally have defined configurations with each of the configurations having certain settings. However, a configuration for a radio bearer during operation may not be ideal for the data being transferred and it may be beneficial to change the configuration of the data bearer.

In order for a change to a configuration of a data bearer to be made during operation, both the UE and the base station exchanging the data will have to know the configuration of the data bearer such that data can be properly exchanged (including proper header encoding and/or decoding, and proper ciphering and/or deciphering). Making both the UE and the base station aware of the configuration of the data bearer involves communication between the UE and the base station. In legacy approaches, reconfiguration of the data radio bearer requires a service request be exchanged via non-access stratum (NAS) signalling and an execution of a radio resource control (RRC) reconfiguration in UL. For DL in legacy approaches, reconfiguration of the data radio bearer requires RRC reconfiguration be signalled by base station to the UE. The RRC configurations can include large amounts of information, which can cause the reconfiguration of the data radio bearer to be quite expensive signalling. This NAS signalling and RRC reconfiguration can have an impact on latency and UE power consumption. Accordingly, the approaches described herein can result in a reduction of latency and UE power consumption when reconfiguring a radio bearer.

### Introduction

In sixth generation (6G), due to new services/quality of service (QoS) requirements it is anticipated that more radio bearers (RBs) with different settings may be required compared to fourth generation (4G)/fifth generation (5G) where 1 default bearer for internet and 1-2 bearers for voice over long term evolution (VoLTE)/voice over new radio (VoNR) for internet protocol multimedia subsystem (IMS) signalling and voice data is very common. Services and their requirements on the radio bearers may be more dynamic with their needs over time, hence the setup/reconfiguration and release approaches described herein may be leaner than in the legacy approaches.

In legacy approaches, a Service Request is required via non-access stratum (NAS) signalling and the execution of radio resource control (RRC) reconfiguration in UL. For DL in legacy approaches, reconfiguration of the data radio bearer requires RRC reconfiguration be signalled by base station to the UE. The RRC reconfigurations can get huge as they contain physical layer (PHY) config (master cell group (MCG)/secondary cell group (SCG)), layer 2 (L2) config, Measurement config, so it can become quite expensive signalling, with many, also big, messages to be exchanged. This has an impact on the latency and the user equipment (UE) power consumption.

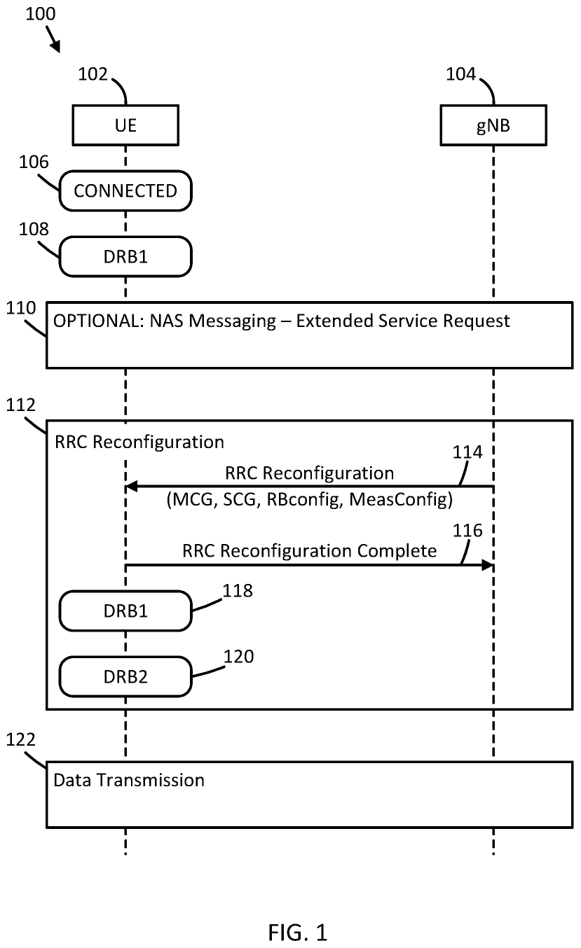

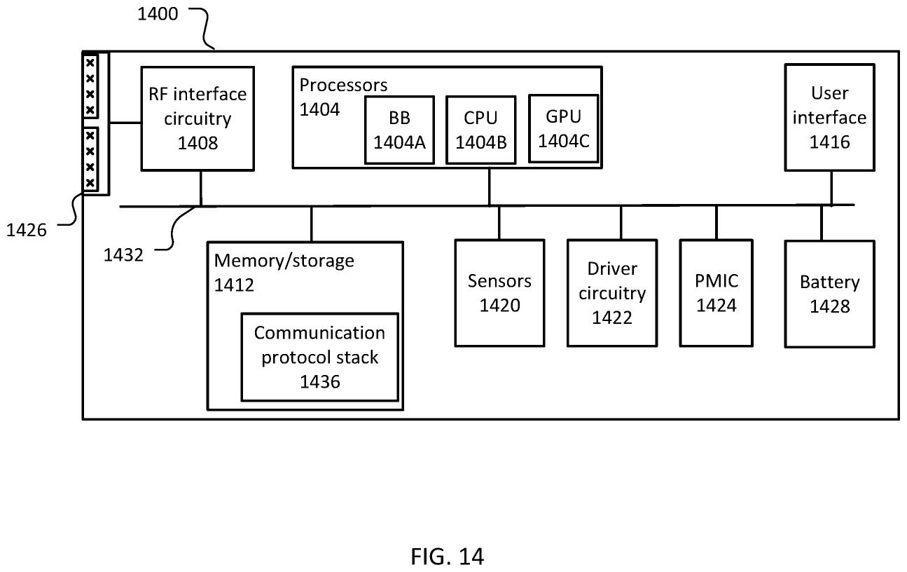

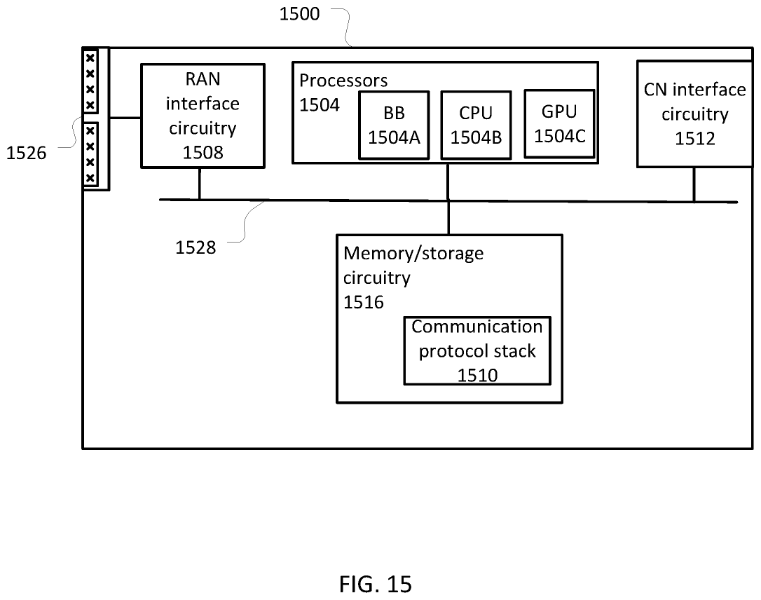

FIG. 1 illustrates an example signal diagram 100 of a radio bearer (RB) reconfiguration in accordance with some embodiments. In particular, the signal diagram 100 illustrates example signals that may be exchanged to affect a reconfiguration of an RB for communication between a UE 102 and a base station 104 (shown as a next generation nodeB (gNB)) in the illustrated embodiment. The UE 102 may include one or more of the features of the UE 1400 (FIG. 14) and the base station 104 may include one or more of the features of the gNB 1500 (FIG. 15).

The UE 102 may be connected to the base station 104 in 106. The connection between the UE 102 and the base station 104 may allow signals to be exchanged between the UE 102 and the base station 104. In the illustrated embodiment, the UE 102 and the base station 104 may be configured to operate with a first data radio bearer (DRB) 108 (which is illustrated at DRB 1) in the illustrated embodiment at the initiation of the signalling shown in the signal diagram 100.

The UE 102 and/or the base station 104 may determine that a configuration of the RBs for transmission of data between the UE 102 and the base station 104 is to be reconfigured. If the UE determines that a reconfiguration of the RBs is to be performed, then the UE 102 may execute a service request 110 (shown as an extended service request in the illustrated embodiment) via NAS messaging between the UE 102 and the base station 104 to request the network to change the RRC configuration. The network can trigger an RRC reconfiguration towards the UE based on the service request 110. In some embodiments, the NAS messaging may indicate settings for a target second RB configuration that require a second RB and/or settings for a target second RB configuration for which reconfiguration is to be performed that indicates that an RB requires reconfiguration. The service request may be optional in some instances.

The UE 102 and the base station 104 may then perform an RRC reconfiguration 112 to reconfigure the DRB. In particular, the base station 104 may transmit an RRC reconfiguration message 114 to the UE 102. The RRC reconfiguration message 114 may include information related to a master cell group (MCG) a secondary cell group (SCG), an RB configuration, a measurement configuration, or some combination thereof. This information included in the RRC reconfiguration message 114 may be relatively large, which may affect latency and/or power consumption of the UE 102.

The UE 102 may reconfigure the RBs on the UE side based on the RRC reconfiguration message 114. The UE 102 may respond with an RRC reconfiguration complete message 116 once the UE 102 has completed reconfiguration of the RBs on the UE side. In the illustrated embodiment, the reconfiguration may result in reconfiguration of a first DRB 118 and setup of a second DRB 120. The base station 104 may receive the RRC reconfiguration complete message 116. In response to receiving the RRC reconfiguration complete message 116, the base station 104 may reconfigure the RBs based on the information within the RRC reconfiguration message 114.

Once both the UE 102 and the base station 104 have completed reconfiguration, the UE 102 and the base station 104 will be able to properly transmit data between the UE 102 and the base station 104 via the second DRB 120. For example, data transmission 122 is shown between the UE 102 and the base station 104 in the illustrated embodiment.

### Uplink (UL) Reflective QoS

In downlink (DL) reflective QoS, the next generation nodeB (gNB) may signal “inline” how QoS flow identifier (QFI) shall be mapped to DRBs in UL based on the applied mapping in DL (reflective QoS flow to DRB mapping indication (RDI)), and/or how UL packets shall be mapped to QFIs based on the characteristics of DL packet that actually carries this information (reflective QoS indication (RQI)). For example, a base station may provide a signal that includes data to the UE. Further, the signal may include an indication of how QFI is to be mapped to DRBs in UL signals based on the applied mapping in DL, and/or an indication of how UL packets are to be mapped to QFIs based on the characteristics of DL packet that carries the information.

Since the UE is more app-aware than the network (NW) and in order to enable more UE control on the QoS in the radio access network (RAN) we may introduce UL reflective QoS. By that, the UE could signal “inline” how QFI shall be mapped to DRBs in DL based on the applied mapping in UL (RDI), or how DL packets shall be mapped to QFIs based on the characteristics of UL packet that actually carries this information (RQI). For example, the UE may transmit a signal with data to a base station. The signal may further include an indication of how QFI is to be mapped to DRBs in DL. How the QFI is to be mapped to the DRBs in DL based on the applied mapping in UL. Further, the signal may include an indication of how DL packets are to be mapped to QFIs. How the DL packets are to be mapped to QFIs based on the characteristics of the UL packet that carries the information (RQI).

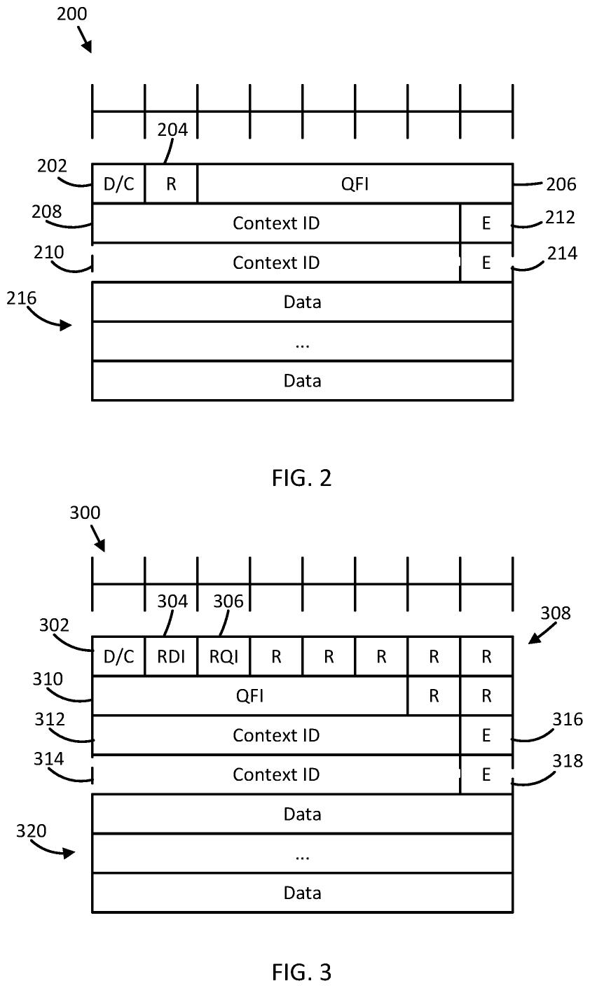

FIG. 2 illustrates an example UL service data adaptation protocol (SDAP) data protocol data unit (PDU) 200 in accordance with some embodiments. For example, the UL SDAP data PDU 200 may be utilized by a UE (such as the UE 1400 (FIG. 14)) to transmit data to a base station (such as the gNB 1500 (FIG. 15)).

The UL SDAP data PDU 200 may include a data/control field 202. The data/control field 202 may indicate whether the transmission that includes the UL SDAP data PDU 200 is a data transmission or a control transmission. For example, D/C in the illustrated example may be data/control. The UL SDAP data PDU 200 may be a data transmission in the illustrated example. For example, the UL SDAP data PDU 200 may be a data PDU in the illustrated embodiment. The UL SDAP data PDU 200 may further include a reserved field 204. For example, R may indicate reserved. The reserved field 204 may be unused and reserved for possible future use.

The UL SDAP data PDU 200 may include a QFI field 206. The QFI field 206 may indicate an RB. In the instances where an ad-hoc DRB is setup and/or configured, a value of the QFI field 206 may be set to indicate the ad-hoc DRB. The value of QFI field 206 include a QoS flow indicator. The QFI field 206 may indicate to a receiving device of the UL SDAP data PDU 200 to which RB the data in the transmission is to be directed. As the UL SDAP data PDU 200 is for a DRB, the QFI field 206 may indicate to which DRB the data is to be transmitted.

The UL SDAP data PDU 200 may include one or more context ID fields. For example, the UL SDAP data PDU 200 includes a first context ID field 208 and a second context ID field 210 in the illustrated embodiment. The context ID fields may indicate preconfigured DRB settings to be utilized for a DRB to be setup, reconfigured or released. For example, Context ID may indicate ID of the preconfigured DRB settings to be used. UEs and base stations within a network may be preconfigured with DRB settings for different configurations, where a context ID within a context field may indicate one of the preconfigured configurations with preconfigured DRB settings. Each of the context ID fields may correspond to a DRB to be setup, reconfigured or released. For example, the first context ID field 208 may correspond to a first DRB to be setup, reconfigured or released and the second context ID field 210 may correspond to a second DRB to be setup, reconfigured or released.

The UL SDAP data PDU 200 may include one or more extension flags. For example, the UL SDAP data PDU 200 includes a first extension flag 212 and a second extension flag 214 in the illustrated embodiment. Each of the extension flags may correspond to a corresponding context ID field. For example, the first extension flag 212 corresponds to the first context ID field 208 and the second extension flag 214 corresponds to the second context ID field 210 in the illustrated embodiment. The extension flags may indicate whether another context ID field follows the corresponding context ID field. For example, the first extension flag 212 indicates whether another context ID field follows the corresponding first context ID field 208 and the second extension flag 214 indicates whether another context ID field follows the corresponding second context ID field 210 in the illustrated embodiment. In some embodiments, an extension flag value of 0 indicates that a header of the UL SDAP data PDU 200 ends and/or no context ID fields follow the corresponding context ID field and an extension flag value of 1 indicates another context ID octet is following. In the illustrated embodiment, the second context ID field 210 and the second extension flag 214 are indicated in dashed lines to indicate the inclusion of the second context ID field 210 and the second extension flag 214 being included in the UL SDAP data PDU 200 may depend on a value of the first extension flag 212.

The UL SDAP data PDU 200 may include data 216. Accordingly, the header of the UL SDAP data PDU 200 may be transmitted in a same transport block (TB) as the data 216. For example, the data 216 may comprise the UL data and the UL data may be transmitted in a same TB as the header of UL SDAP data PDU 200.

The UE may transmit the UL SDAP data PDU 200 on a UL TB to the base station. The data 216 may be arranged and/or encoded in accordance with the configuration corresponding to the value of the one of the context IDs for the DRB indicated in the header of the UL SDAP data PDU 200 when transmitted in the UL TB. Accordingly, the header of the UL SDAP data PDU 200 may indicate the configuration of the DRB transporting the data 216. The indication of the configuration of the DRB may be transported in the same UL TB as the data to which the configuration of the DRB is to apply.

FIG. 3 illustrates an example UL SDAP data PDU 300 in accordance with some embodiments. For example, the UL SDAP data PDU 300 may be utilized by a UE (such as the UE 1400 (FIG. 14)) to transmit data to a base station (such as the gNB 1500 (FIG. 15)).

The UL SDAP data PDU 300 may include a data/control field 302. The data/control field 302 may indicate whether the transmission that includes the UL SDAP data PDU 300 is a data transmission or a control transmission. For example, D/C in the illustrated example may be data/control. The UL SDAP data PDU 300 may be a data transmission in the illustrated example. For example, the UL SDAP data PDU 300 may be a data PDU in the illustrated embodiment.

The UL SDAP data PDU 300 may include an RDI field 304. The RDI field 304 may indicate whether the base station is to update QoS flow to DRB mapping for DL. For example, the RDI field 304 may be set with a value of 1 to indicate that the base station is to update the QoS flow to DRB mapping for downlink, and may be set with a value of 0 to indicate that the base station is not to update the QoS flow to DRB mapping for downlink in some embodiments.

The UL SDAP data PDU 300 may include an RQI field 306. The RQI field 306 may indicate whether the base station is to update service data flow to QoS mapping rules for downlink. For example, the RQI field 306 may be set with a value of 1 to indicate that the base station is to update the service data flow to QoS mapping rules for downlink, and may be set with a value of 0 to indicate that the base station is not to update the service data flow to QoS mapping rules for downlink.

The UL SDAP data PDU 300 may further include one or more reserved fields 308. For example, R may indicate reserved. The reserved fields 308 may be unused and reserved for possible future use.

The UL SDAP data PDU 300 may include a QFI field 310. The QFI field 310 may indicate an RB to which a QFI is to be mapped. In the instances where an ad-hoc DRB is setup and/or configured, a value of the QFI field 310 may be set to indicate the ad-hoc DRB. The value of QFI field 310 include a QoS flow indicator. The QFI field 310 may indicate to a receiving device of the UL SDAP data PDU 300 to which RB the data in the transmission is to be directed. As the UL SDAP data PDU 300 is for a DRB, the QFI field 310 may indicate to which DRB the data is to be transmitted.

The UL SDAP data PDU 300 may include one or more context ID fields. For example, the UL SDAP data PDU 300 includes a first context ID field 312 and a second context ID field 314 in the illustrated embodiment. The context ID fields may indicate preconfigured DRB settings to be utilized for a DRB to be setup, reconfigured or released. For example, Context ID may indicate ID of the preconfigured DRB settings to be used. UEs and base stations within a network may be preconfigured with DRB settings for different configurations, where a context ID within a context field may indicate one of the preconfigured configurations with preconfigured DRB settings. Each of the context ID fields may correspond to a DRB to be setup, reconfigured or released. For example, the first context ID field 312 may correspond to a first DRB to be setup, reconfigured or released and the second context ID field 314 may correspond to a second DRB to be setup, reconfigured or released.

The UL SDAP data PDU 300 may include one or more extension flags. For example, the UL SDAP data PDU 300 includes a first extension flag 316 and a second extension flag 318 in the illustrated embodiment. Each of the extension flags may correspond to a corresponding context ID field. For example, the first extension flag 316 corresponds to the first context ID field 312 and the second extension flag 318 corresponds to the second context ID field 314 in the illustrated embodiment. The extension flags may indicate whether another context ID field follows the corresponding context ID field. For example, the first extension flag 316 indicates whether another context ID field follows the corresponding first context ID field 312 and the second extension flag 318 indicates whether another context ID field follows the corresponding second context ID field 314 in the illustrated embodiment. In some embodiments, an extension flag value of 0 indicates that a header of the UL SDAP data PDU 300 ends and/or no context ID fields follow the corresponding context ID field and an extension flag value of 1 indicates another context ID octet is following. In the illustrated embodiment, the second context ID field 314 and the second extension flag 318 are indicated in dashed lines to indicate the inclusion of the second context ID field 314 and the second extension flag 318 being included in the UL SDAP data PDU 300 may depend on a value of the first extension flag 316. The header of the UL SDAP data PDU 300 may include the data/control field 302, the RDI field 304, the RQI field 306, the one or more reserved fields 308, the QFI field 310, the one or more context ID fields, and/or the one or more extension flags.

The UL SDAP data PDU 300 may include data 320. Accordingly, the header of the UL SDAP data PDU 300 may be transmitted in a same TB as the data 320. For example, the data 320 may comprise the UL data and the UL data may be transmitted in a same TB as the header of UL SDAP data PDU 300.

The UE may transmit the UL SDAP data PDU 300 on a UL TB to the base station. The data 320 may be arranged and/or encoded in accordance with the configuration corresponding to the value of the one of the context IDs for the DRB indicated in the header of the UL SDAP data PDU 300 when transmitted in the UL TB. Accordingly, the header of the UL SDAP data PDU 300 may indicate the configuration of the DRB transporting the data 320. The indication of the configuration of the DRB may be transported in the same UL TB as the data to which the configuration of the DRB is to apply.

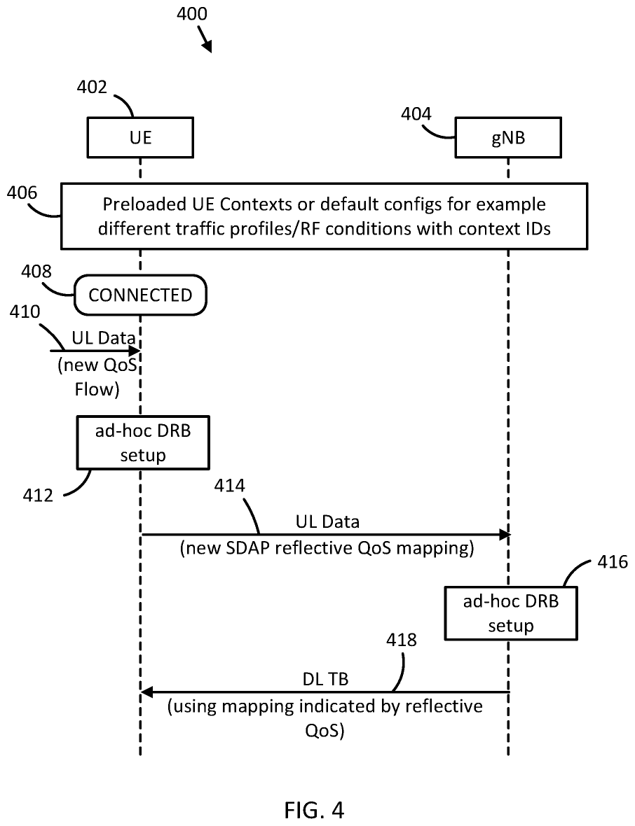

FIG. 4 illustrates an example signal diagram 400 in accordance with some embodiments. The illustrated example shows an example setup of an ad-hoc DRB in accordance with some embodiments.

The DRB setup example may occur between a UE 402 and a base station 404. The UE 402 may include one or more of the features of the UE 1400 (FIG. 14), and the base station 404 may include one or more of the features of the gNB 1500 (FIG. 15). In the illustrated example, the UE 402 may originate the DRB setup and the base station 404 may receive information from the UE 402 for configuration of the DRB. The UE 402 and the base station 404 may have preloaded UE contexts and/or default configurations stored as indicated by 406. The preloaded UE contexts and/or default configurations may be for different traffic profiles and/or RF conditions. Further, the preloaded UE contexts and/or default configurations may include secure IDs. The UE 402 may be connected to the base station 404 as indicated by 408.

The UE 402 may receive UL data 410 to be provided to the base station 404. The UL data 410 may have an indication of a QoS flow ID. The UE 402 may determine to setup an ad-hoc DRB to ensure the QoS for the UL data 410. For example, the UE 402 receives a packet with QoS flow ID. To ensure the required QoS, the UE 402 may decide to setup a new ad-hoc DRB and indicate that to the base station 404 via SDAP by adding context ID information into a UL SDAP data PDU (such as the UL SDAP data PDU 300 (FIG. 3)). The UE 402 may determine a configuration for a DRB to carry the UL data 410 based on the UL data 410. For example, the UE 402 may determine the configuration for the DRB based on QoS requirements, application end-to-end latency, privacy/security needs, small/medium/large amounts of data, congestion based, using transmission (TX)/reception (RX) window information on different levels, offloading capabilities, and/or radio frequency (RF) conditions like cell edge, packet loss rates related to the UL data 410. These elements utilized for determining the configuration may be referred to as configuration considerations throughout this disclosure.

To ensure the required QoS, the UE 402 may decide to setup a new ad-hoc DRB. For example, the UE 402 may decide to setup a new ad-hoc DRB to meet the configuration determined for the DRB. The UE 402 may perform an ad-hoc DRB setup 412 to setup the new ad-hoc DRB. The UE 402 may map the UL data 410 to the DRB setup by the ad-hoc DRB setup 412.

The UE 402 may transmit the UL SDAP data PDU with the UL data 410 in a transmission 414 to the base station 404. The UL data 410 may be arranged and/or encoded in accordance with the configuration corresponding to the value of the one of the context IDs for the DRB indicated in the header of the UL SDAP data PDU when transmitted in the transmission 414. Accordingly, the header may indicate the configuration of the DRB transporting the UL data 410. The indication of the configuration of the DRB may be transported in the same transmission 414 as the data to which the configuration of the DRB is to apply.

The base station 404 may receive the transmission 414 from the UE 402. The base station 404 may receive the transmission 414 on a MAC layer, and may demultiplex and map the transmission 414 according to the RB configuration. The base station 404 may identify the header within the transmission 414 and determine the configuration for the DRB from the header, how the QFI is to be mapped to DRBs, and/or how DL packets are to be mapped to QFIs. The base station 404 may establish a corresponding ad-hoc DRB to properly decode the transmission 414. For example, upon reception and decoding of the header, the base station 404 may determine based on context ID which configuration to apply and can establish the corresponding ad-hoc DRB in order to properly decode the packet further. Further, the base station 404 may determine how QFI is to be mapped to DRBs in DL based on the mapping in the UL, and/or may determine how DL packets are to be mapped to QFIs based on the characteristics of the UL packet that carries the information (such as the UL SDAP data PDU). The base station 404 can derive the DL filters based on the indicated QFI in the received packet. In the illustrated example, the base station 404 may determine that the DRB is to be configured with the configuration corresponding to the one of the context IDs indicated in the header of the UL SDAP data PDU.

The base station 404 may perform an ad-hoc DRB setup 416 to configure the UE side with the determined configuration. In some embodiments, an SDAP may decode the header and perform the ad-hoc DRB setup 416. The base station 404 may retrieve the determined configuration from memory to configure the DRB via the ad-hoc DRB setup 416.

The base station 404 may utilize the configuration of the DRB to process the UL data 410 received in the transmission 414. For example, the base station 404 may decode the UL data 410 in accordance with the configuration of the DRB.

The base station 404 may utilize the configuration of the DRB for transmissions of one or more TBs. For example, the base station 404 may encode transmissions to be transported to the UE 402 in accordance with the configuration. In the illustrated example, the base station 404 may transmit a DL TB 418 to the UE 402. The base station 404 may utilize the configuration and/or mapping indicated by the reflective QoS for transmission of the DL TB 418. The base station 404 may determine the configuration for the ad-hoc DRB and/or the mapping indicated by the reflective QoS from the header of the UL SDAP data PDU.

The UL reflective QoS approach may provide one or more benefits. For example, the benefits may include adding UE control on the QoS in the RAN allowing for smarter, more application/service-aware architecture where the UE is in control. Further, the benefits may include increases security and privacy as the breakdown of different applications/services to QFIs is UE controlled and only QFIs and the related QoS parameters are shared. NW does not need to know the different Applications/Services.

This UL reflective QoS fits well with the ad-hoc bearers via SDAP. UE can control DRBs setup/release/reconfiguration as well as QFI to DRB mapping and packet to QFI mapping.

FIG. 5 illustrates an example UL SDAP data PDU 500 in accordance with some embodiments. For example, the UL SDAP data PDU 500 may be utilized by a UE (such as the UE 1400 (FIG. 14)) to transmit data to a base station (such as the gNB 1500 (FIG. 15)). The UL SDAP data PDU 500 may be utilized to change a QoS flow without setup, reconfiguration, and/or release of an ad-hoc DRB.

The UL SDAP data PDU 500 may include a data/control field 502. The data/control field 502 may indicate whether the transmission that includes the UL SDAP data PDU 500 is a data transmission or a control transmission. For example, D/C in the illustrated example may be data/control. The UL SDAP data PDU 500 may be a data transmission in the illustrated example. For example, the UL SDAP data PDU 500 may be a data PDU in the illustrated embodiment. The UL SDAP data PDU 500 may further include a reserved field 504. For example, R may indicate reserved. The reserved field 504 may be unused and reserved for possible future use.

The UL SDAP data PDU 500 may include a QFI field 506. The QFI field 506 may indicate an RB. The value of QFI field 506 include a QoS flow indicator. The QFI field 506 may indicate to a receiving device of the UL SDAP data PDU 500 to which RB the data in the transmission is to be directed. As the UL SDAP data PDU 500 is for a DRB, the QFI field 506 may indicate to which DRB the data is to be transmitted.

The UL SDAP data PDU 500 may include data 508. Accordingly, the header of the UL SDAP data PDU 500 may be transmitted in a same TB as the data 508. For example, the data 508 may comprise the UL data and the UL data may be transmitted in a same TB as the header of UL SDAP data PDU 500.

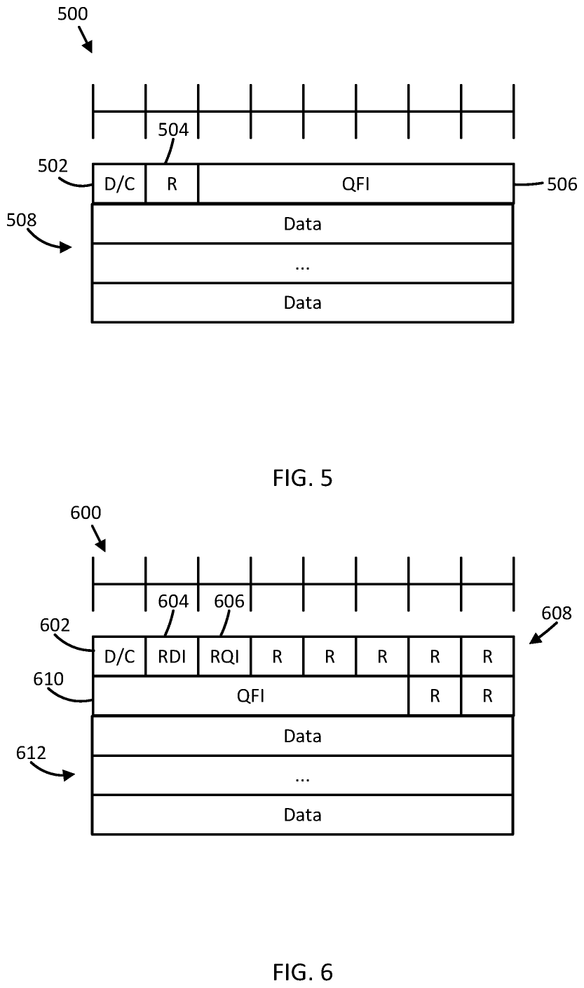

FIG. 6 illustrates an example UL SDAP data PDU 600 in accordance with some embodiments. For example, the UL SDAP data PDU 600 may be utilized by a UE (such as the UE 1400 (FIG. 14)) to transmit data to a base station (such as the gNB 1500 (FIG. 15)). The UL SDAP data PDU 600 may be utilized to change a QoS flow without setup, reconfiguration, and/or release of an ad-hoc DRB.

The UL SDAP data PDU 600 may include a data/control field 602. The data/control field 602 may indicate whether the transmission that includes the UL SDAP data PDU 600 is a data transmission or a control transmission. For example, D/C in the illustrated example may be data/control. The UL SDAP data PDU 600 may be a data transmission in the illustrated example. For example, the UL SDAP data PDU 600 may be a data PDU in the illustrated embodiment.

The UL SDAP data PDU 600 may include an RDI field 604. The RDI field 604 may indicate whether the base station is to update QoS flow to DRB mapping for DL. For example, the RDI field 604 may be set with a value of 1 to indicate that the base station is to update the QoS flow to DRB mapping for downlink, and may be set with a value of 0 to indicate that the base station is not to update the QoS flow to DRB mapping for downlink in some embodiments.

The UL SDAP data PDU 600 may include an RQI field 606. The RQI field 606 may indicate whether the base station is to update service data flow to QoS mapping rules for downlink. For example, the RQI field 606 may be set with a value of 1 to indicate that the base station is to update the service data flow to QoS mapping rules for downlink, and may be set with a value of 0 to indicate that the base station is not to update the service data flow to QoS mapping rules for downlink.

The UL SDAP data PDU 600 may further include one or more reserved fields 608. For example, R may indicate reserved. The reserved fields 608 may be unused and reserved for possible future use.

The UL SDAP data PDU 600 may include a QFI field 610. The QFI field 610 may indicate an RB to which a QFI is to be mapped. The value of QFI field 610 include a QoS flow indicator. The QFI field 610 may indicate to a receiving device of the UL SDAP data PDU 600 to which RB the data in the transmission is to be directed. As the UL SDAP data PDU 600 is for a DRB, the QFI field 610 may indicate to which DRB the data is to be transmitted.

The UL SDAP data PDU 600 may include data 612. Accordingly, the header of the UL SDAP data PDU 600 may be transmitted in a same TB as the data 612. For example, the data 612 may comprise the UL data and the UL data may be transmitted in a same TB as the header of UL SDAP data PDU 600.

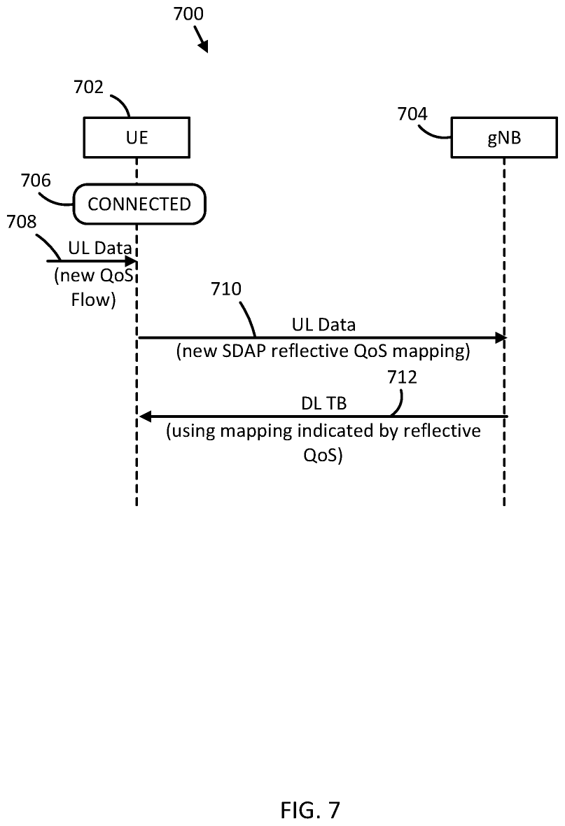

FIG. 7 illustrates an example signal diagram 700 in accordance with some embodiments. The illustrated example shows an example signal diagram for SDAP reflective QoS mapping in accordance with some embodiments. For example, the signal diagram 700 may indicate signals for updates to QoS flow mapping and/or QoS mapping rules for DL.

The illustrated example may occur between a UE 702 and a base station 704. The UE 702 may include one or more of the features of the UE 1400 (FIG. 14), and the base station 704 may include one or more of the features of the gNB 1500 (FIG. 15). In the illustrated example, the UE 702 may originate the QoS updates and the base station 704 may receive information from the UE 702 for the QoS updates. The UE 702 may be connected to the base station 704 as indicated by 706.

The UE 702 may receive UL data 708 to be provided to the base station 704. The UL data 708 may have an indication of a QoS flow ID. The UE 702 may determine based on the UL data 708 whether QoS updates are to be made. For example, the UE 702 may determine whether QoS flow mapping and/or QoS mapping rules are to be updated for DL.

The UE 702 may generate a UL SDAP data PDU (such as the UL SDAP data PDU 500 (FIG. 5) and/or the UL SDAP data PDU 600 (FIG. 6)) that may indicate whether QoS updates are to be made. The UL SDAP data PDU may indicate whether QoS flow to DRB mapping for DL is to be updated, whether QoS mapping rules for DL are to be updated, and/or a QoS flow indicator.

The UE 702 may transmit the UL SDAP data PDU with the UL data 708 in a transmission 710 to the base station 704. The UL SDAP data PDU may indicate to the base station 704 whether DRB mapping and/or QoS mapping rules are to be updated for DL, and/or a QoS flow indicator.

The base station 704 may receive the transmission 710 from the UE 702. The base station 704 may receive the transmission 710 on a MAC layer, and may demultiplex and map the transmission 714. The base station 704 may identify the header within the transmission 714 and determine how the QFI is to be mapped to DRBs, and/or how DL packets are to be mapped to QFIs. The base station 704 may determine how QFI is to be mapped to DRBs in DL based on the mapping in the UL, and/or may determine how DL packets are to be mapped to QFIs based on the characteristics of the UL packet that carries the information (such as the UL SDAP data PDU). The base station 704 can derive the DL filters based on the indicated QFI in the received packet.

The base station 704 may transmit a DL TB 712 to the UE 702. The base station 704 may utilize the mapping indicated by the reflective QoS for transmission of the DL TB 712. The base station 704 may determine the mapping indicated by the reflective QoS from the header of the UL SDAP data PDU.

The UL reflective QoS approach may provide one or more benefits. For example, the benefits may include adding UE control on the QoS in the RAN allowing for smarter, more application/service-aware architecture where the UE is in control. Further, the benefits may include increases security and privacy as the breakdown of different applications/services to QFIs is UE controlled and only QFIs and the related QoS parameters are shared. NW does not need to know the different Applications/Services.

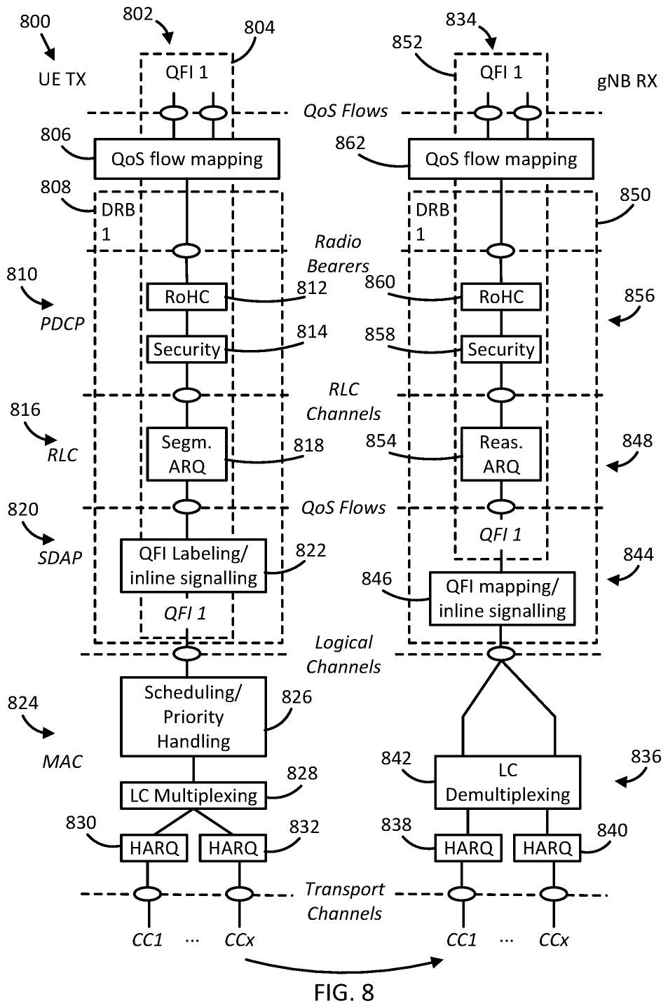

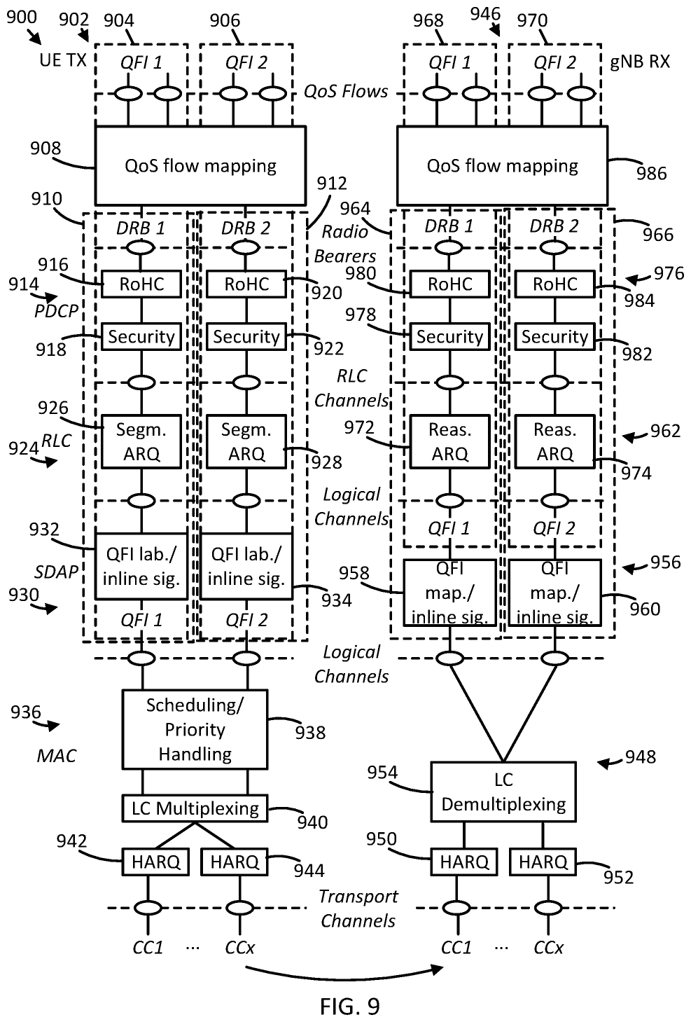

FIG. 8 and FIG. 9 illustrates example QoS flows based on a UL SDAP data PDU in accordance with some embodiments. In particular, FIG. 8 illustrates an example QoS flow 800 prior to reconfiguration based on a UL SDAP data PDU in accordance with some embodiments. FIG. 9 illustrates an example QoS flow 900 after reconfiguration based on a UL SDAP data PDU in accordance with some embodiments. For example, an UL SDAP data PDU (such as the UL SDAP data PDU 300 (FIG. 3)) may cause a configuration change from the QoS flow 800 to the QoS flow 900.

The UL example illustrated by FIG. 8 and FIG. 9 may be configured with the following. Initially, (shown in FIG. 8), UE only has QFI=1 as configured by a base station (which may be a gNB). To ensure the required QoS of an application/service the UE may decide to create a new packet filter to map those packets to QFI=2, setup a new ad-hoc DRB 2, map newly defined QFI=2 to the new DRB 2, and/or, at SDAP layer (below RLC), add the SDAP header indicating QFI=2, RDI=1 and RQI=1, and New Context ID(s) to indicate the establishment of ad-hoc bearer(s) of this context(s) before this packet can be decoded properly.

The QoS flow 800 illustrates a QoS flow for transmissions from a UE (such as the UE 402 (FIG. 4) and/or the UE 1400 (FIG. 14)) to a base station (such as the base station 404 (FIG. 4) and/or the gNB 1500 (FIG. 15)). The QoS flow 800 may be a QoS flow prior to processing of a UL SDAP data PDU in accordance with some embodiments.

The QoS flow 800 may include a UE transmission flow 802. The UE transmission flow 802 illustrates an example QoS flow of QoS flow packets for transmission from the UE. In the illustrated embodiment, the UE transmission flow 802 may include a QFI 804. The QFI 804 may be mapped to corresponding QoS flows. For example, the UE transmission flow 802 may include a QoS flow mapping operation 806 that maps the QFI 804 to the corresponding QoS flow. The QoS flow mapping operation 806 may be performed above the layers described below.

The QoS flow mapping operation 806 may map the QFI 804 to corresponding DRBs. The illustrated embodiment includes a DRB 808 (labelled DRB 1). In some of the embodiments, the UE transmission flow may include one or more of the DRBs. The QoS flow mapping operation 806 may map the QFI 804 to the DRB 808 in the illustrated embodiment.

The UE transmission flow 802 may include a PDCP layer 810. The PDCP layer 810 may be a top layer of the UE transmission flow 802. The PDCP layer 810 may receive the DRBs from the QoS flow mapping operation 806 and perform one or more operations with the DRBs. For example, the PDCP layer 810 may receive the DRB 808, and may perform operations with the DRB 808. The PDCP layer 810 may perform operations such as RoHC and/or security operations. For example, an RoHC 812 and a security operation 814 may be applied to the DRB 808. The PDCP layer 810 may route the DRBs to corresponding RLC channels.

The UE transmission flow 802 may include an RLC layer 816. The RLC layer 816 may be located below the PDCP layer 810. The RLC layer 816 may receive the RLC channels from the PDCP layer 810. The RLC layer 816 may produce RLC SDUs with the RLC channels and segment the SDUs. Further, the RLC layer 816 may further provide automatic repeat request. The operations performed by the RLC layer 816 may be performed in 818 for the DRB 808. The RLC layer 816 may map the SDUs to QoS flows.

The UE transmission flow 802 may include an SDAP layer 820. The SDAP layer 820 may be located below the RLC layer 816. Further, the SDAP layer 820 may be located between the RLC layer 816 and a MAC layer 824. The SDAP layer 820 may receive the RLC SDUs from the RLC layer 816. The SDAP layer 820 may perform QFI labelling and/or QFI inline signalling operations with the QoS flows. For example, the QFI labelling and/or QFI inline signalling operations 822 may be applied to the QFI 804. Having the QFI labelling and inline signalling operations below the RLC layer 816 may allow proper labelling and DRB configuration information to be applied to the transmissions for changes that may be due to ad-hoc DRB operations. For example, ad-hoc DRB operations may result in the QoS flow mapping operation 806 to be changed, which could result in different QFIs being directed to different DRBs. Having the QFI labelling and inline signalling operations below the RLC layer 816 may assure that the QFI are mapped correctly. The SDAP layer 820 may map the RLC SDUs to LCs.

The UE transmission flow 802 may include a MAC layer 824. The MAC layer 824 may be located below the SDAP layer 820. The MAC layer 824 may receive the LCs from the SDAP layer 820. The MAC layer 824 may perform one or more operations with the LCs. In the illustrated embodiment, the MAC layer 824 may perform a scheduling/priority handling operation 826, an LC multiplexing operation 828, and a first HARQ operation 830 and a second HARQ operation 832 with the LCs. The MAC layer 824 may direct the LCs to component carriers (CCs) for transmission to a base station.

The QoS flow 800 may further include a base station reception flow 834. The base station reception flow 834 may illustrate QoS flow of QoS flow packets received by a base station from a UE. In the particular embodiment, the base station reception flow 834 illustrates an example QoS flow of QoS flow packets received from the UE transmission flow 802. In particular, the UE transmission flow 802 may provide signals via the CCs on transport channels to the base station reception flow 834.

The base station reception flow 834 may include a MAC layer 836. The MAC layer 836 may be a bottom layer of the base station reception flow 834. The MAC layer 836 may receive the CCs from the UE transmission flow 802 and may perform one or more operations with the CCs. In the illustrated embodiment, the MAC layer 836 may perform a first HARQ operation 838 and a second HARQ operation 840, and an LC demultiplexing operation 842 with the CCs. The MAC layer 836 may map the CCs to LCs and produce SDAP PDUs.

The base station reception flow 834 may include an SDAP layer 844. The SDAP layer 844 may be located above the MAC layer 836. Further, the SDAP layer 844 may be located below an RLC layer 848. Accordingly, the SDAP layer 844 may be located between the RLC layer 848 and the MAC layer 836. The SDAP layer 844 may receive the LCs from the MAC layer 836. The SDAP layer 844 may map the LCs to the proper DRBs. For example, the SDAP layer 844 may map some of the data to a DRB 850 (labelled DRB 1).

The SDAP layer 844 may perform one or more operations on the LCs. For example, the SDAP layer 844 may perform QFI mapping and/or inline signalling operations. A QFI mapping operation and/or inline signalling operation 846 may map each of the LCs to the QFI 852. Further, the SDAP layer 844 may direct the LCs to the proper DRB. For example, the SDAP layer 844 may direct the LCs to the DRB 850. The SDAP layer 844 may output the LCs to QoS flows. By having the SDAP layer 844 below the RLC layer 848 and directing the LC to the proper QFI and/or DRB may provide for proper decoding in the instance of ad-hoc radio bearer approaches. Having the SDAP layer 844 above the RLC layer 848 may result in improper decoding of the LCs.

The base station reception flow 834 may include an RLC layer 848. The RLC layer 848 may be located above the SDAP layer 844. The RLC layer 848 may receive the QoS flows from the SDAP layer 844 and may perform one or more operations with the QoS flows. In the illustrated embodiment, the RLC layer 848 may reassemble the RLC PDUs in 854 to produce PDCP PDUs and map the reassembled PDCP PDUs to RLC channels. Further, the RLC layer 848 may perform automatic repeat request operations in 854.

The base station reception flow 834 may include a PDCP layer 856. The PDCP layer 856 may be located above the RLC layer 848. The PDCP layer 856 may receive the PDCP PDUs from the RLC layer 848. The PDCP layer 856 may perform one or more operations on the PDCP PDUs. For example, the PDCP layer 856 may perform operations, such as security operations and/or RoHC operations, to the PDCP PDUs. The PDCP layer 856 may perform security operations 858 and RoHC 860 on the DRB 850. The PDCP layer 856 may route the RLC channels to one or more RBs.

The base station reception flow 834 may include a QoS flow mapping operation 862. The QoS flow mapping operation 862 may be located above the PDCP layer 856. The QoS flow mapping operation 862 may receive the DRB from the PDCP layer 856. Further, the QoS flow mapping operation 862 may map the DRBs to QoS flows.

When the base station (which may be gNB) receives the packet on MAC layer it may demultiplex and map it according to the current RB configuration. Since this packet was transmitted via a newly established ad-hoc bearer there is no mapping to LC available, the packet may be given to SDAP without LC and SDAP can continue the decoding of the SDAP header and setup the receiving side of the ad-hoc DRB(s) according to the indicated Context ID(s). For example, when the base station receives UL data implementing the SDAP reflective QoS mapping described herein with a UL SDAP data PDU (such as the UL SDAP data PDU 300 (FIG. 3)), there may be no defined mapping to LC for UL data. An SDAP layer of the base station may receive the UL SDAP data PDU. The SDAP layer may decode the header of the UL SDAP data PDU and setup the ad-hoc DRB or DRBs according to a value of the context ID or values of context IDs within the header. The SDAP layer may utilize the value of the context ID or the values of the context IDs to determine one or more configurations stored on the base station to be utilized for the ad-hoc DRB or DRBs.

The SDAP layer at the gNB may now use the newly introduced RDI and RQI fields to setup, reconfigure, or release ad-hoc DRBs. For example, the SDAP layer may utilize RDI=1 in the illustrated example, which means that it would update the QoS flow to DRB mapping rule for DL based on the mapping defined in UL. Further, the SDAP layer may utilize RQI=1 in the illustrated example, which means that DL packets shall be mapped to QFIs based on the characteristics of UL packet that actually carries this information. After that the SDAP layer can forward the data correctly as shown in FIG. 9.

The QoS flow 900 illustrates a QoS flow for transmissions from a UE (such as the UE 402 (FIG. 4) and/or the UE 1400 (FIG. 14)) to a base station (such as the base station 404 (FIG. 4) and/or the gNB 1500 (FIG. 15)). The QoS flow 900 may be a QoS flow after processing of a UL SDAP data PDU in accordance with some embodiments.

The QoS flow 900 may include a UE transmission flow 902. The UE transmission flow 902 illustrates an example QoS flow of QoS flow packets for transmission from the UE. In the illustrated embodiment, the UE transmission flow 902 may include a first QFI 904 and a second QFI 906. In the illustrated example, the second QFI 906 may have been established by the UE through an ad-hoc DRB setup (such as the ad-hoc DRB setup 412). The second QFI 906 may be established with a configuration determined by the UE based on the configuration considerations for the DRB. The first QFI 904 and the second QFI 906 may correspond to QoS flows within the UE transmission flow 902.

The first QFI 904 and the second QFI 906 may be mapped to corresponding DRBs. For example, the UE transmission flow 902 may include a QoS flow mapping operation 908 that maps the first QFI 904 and the second QFI 906 to corresponding DRBs. The QoS flow mapping operation 908 may direct the first QFI 904 and the second QFI 906 to a first DRB 910 and/or a second DRB 912 in the illustrated embodiment. In the illustrated embodiment, the second DRB 912 may have been established through the ad-hoc DRB setup. The QoS flow mapping operation 908 may direct the QFIs to the DRBs according to the configurations for the first DRB 910 and the second DRB 912. The QoS flow mapping operation 908 may be performed above the layers described below.

The UE transmission flow 902 may include a PDCP layer 914. The PDCP layer 914 may be a top layer of the UE transmission flow 902. The PDCP layer 914 may receive the DRBs from the QoS flow mapping operation 908 and perform one or more operations with the DRBs. For example, the PDCP layer 914 may receive the first DRB 910 and the second DRB 912, and may perform operations with the first DRB 910 and the second DRB 912. The PDCP layer 914 may perform operations such as RoHC and/or security operations. For example, a first RoHC 916 and a first security operation 918 may be applied to the first DRB 910, and a second RoHC 920 and a second security operation 922 may be applied to the second DRB 912 in the illustrated embodiment. The first RoHC 916 and the second RoHC 920 may be the same operation and/or different operations, and the first security operation 918 and the second security operation 922 may be the same operation and/or different operations in the illustrated embodiment. The PDCP layer 914 may route the DRBs to corresponding RLC channels.

The UE transmission flow 902 may include an RLC layer 924. The RLC layer 924 may be located below the PDCP layer 914. The RLC layer 924 may receive the RLC channels from the PDCP layer 914. The RLC layer 924 may segment the SDUs and add RLC headers producing RLC PDUs with the RLC channels. Further, the RLC layer 924 may further provide automatic repeat request. The operations performed by the RLC layer 924 may be performed in 926 for the first DRB 910 and in 928 for the second DRB 912.

The UE transmission flow 902 may include an SDAP layer 930. The SDAP layer 930 may be located below the RLC layer 924. Further, the SDAP layer 930 may be located between the RLC layer 924 and a MAC layer 936. The SDAP layer 930 may receive the RLC SDUs from the RLC layer 924. The SDAP layer 930 may perform QFI labelling and/or QFI inline signalling operations with the QoS flows. For example, QFI labelling and/or QFI inline signalling operations 932 may be applied to the first DRB 910 and QFI labelling and/or QFI inline signalling operations 934 may be applied to the second DRB 912. The SDAP layer 930 may apply a header (such as the header of the header of the UL SDAP data PDU 300) to the first DRB 910 and/or the second DRB 912 to indicate configurations of the first DRB 910 and/or the second DRB 912. Having the QFI labelling and inline signalling operations below the RLC layer 924 may allow proper labelling and DRB configuration information to be applied to the transmissions for changes that may be due to ad-hoc DRB operations. For example, ad-hoc DRB operations may result in the QoS flow mapping operation 908 to be changed, which could result in different QFIs being directed to different DRBs. Having the QFI labelling and inline signalling operations below the RLC layer 924 may assure that the QFI are mapped correctly. The SDAP layer 930 may map the RLC SDUs to LCs.

The UE transmission flow 902 may include a MAC layer 936. The MAC layer 936 may be located below the SDAP layer 930. The MAC layer 936 may receive the LCs from the SDAP layer 930. The MAC layer 936 may perform one or more operations with the LCs. In the illustrated embodiment, the MAC layer 936 may perform a scheduling/priority handling operation 938, an LC multiplexing operation 940, and a first HARQ operation 942 and a second HARQ operation 944 with the LCs. The MAC layer 936 may direct the LCs to component carriers (CCs) for transmission to a base station.

The QoS flow 900 may further include a base station reception flow 946. The base station reception flow 946 may illustrate QoS flow of QoS flow packets received by a base station from a UE. In the particular embodiment, the base station reception flow 946 illustrates an example QoS flow of QoS flow packets received from the UE transmission flow 902. In particular, the UE transmission flow 902 may provide signals via the CCs on transport channels to the base station reception flow 946.

The base station reception flow 946 may include a MAC layer 948. The MAC layer 948 may be a bottom layer of the base station reception flow 946. The MAC layer 948 may receive the CCs from the UE transmission flow 902 and may perform one or more operations with the CCs. In the illustrated embodiment, the MAC layer 948 may perform a first HARQ operation 950 and a second HARQ operation 952, and an LC demultiplexing operation 954 with the CCs. The MAC layer 948 may map the CCs to LCs and produce SDAP PDUs.

The base station reception flow 946 may include an SDAP layer 956. The SDAP layer 956 may be located above the MAC layer 948. Further, the SDAP layer 956 may be located below an RLC layer 962. Accordingly, the SDAP layer 956 may be located between the RLC layer 962 and the MAC layer 948. The SDAP layer 956 may receive the LCs from the MAC layer 948. The SDAP layer 956 may map the LCs to the proper DRBs. For example, the SDAP layer 956 may map some of the data to a first DRB 964 and some of the data to a second DRB 966.

The SDAP layer 956 may perform one or more operations on the LCs. For example, the SDAP layer 956 may perform QFI mapping and/or inline signalling operations. A first QFI mapping operation and/or inline signalling operation 958 and a second QFI mapping operation and/or inline signalling operation 960 may map each of the LCs to a corresponding QFI of a first QFI 968 and a second QFI 970. The QFI mapping operations and/or inline signalling operations may update the QoS flow to DRB mapping rule for DL based on the mapping defined in UL and/or the mapping of the DL packets to QFIs based on the characteristics of the UL packet received from the UE. The SDAP layer 956 may output the LCs to QoS flows. By having the SDAP layer 956 below the RLC layer 962 and directing the LC to the proper QFI and/or DRB may provide for proper decoding in the instance of ad-hoc radio bearer approaches. Having the SDAP layer 956 above the RLC layer 962 may result in improper decoding of the LCs.

The base station reception flow 946 may include an RLC layer 962. The RLC layer 962 may be located above the SDAP layer 956. The RLC layer 962 may receive the QoS flows from the SDAP layer 956 and may perform one or more operations with the QoS flows. In the illustrated embodiment, the RLC layer 962 may reassemble the RLC PDUs in 972 and 974 to produce PDCP PDUs and map the reassembled PDCP PDUs to RLC channels. Further, the RLC layer 962 may perform automatic repeat request operations in 972 and 974.

The base station reception flow 946 may include a PDCP layer 976. The PDCP layer 976 may be located above the RLC layer 962. The PDCP layer 976 may receive the PDCP PDUs from the RLC layer 962. The PDCP layer 976 may perform one or more operations on the PDCP PDUs. For example, the PDCP layer 976 may perform operations, such as security operations and/or RoHC operations, to the PDCP PDUs. The PDCP layer 976 may perform first security operations 978 and first RoHC 980 on the first DRB 964, and may perform second security operations 982 and second RoHC 984 on the second DRB 966. The PDCP layer 976 may route the RLC channels to one or more RBs.

The base station reception flow 946 may include a QoS flow mapping operation 986. The QoS flow mapping operation 986 may be located above the PDCP layer 976. The QoS flow mapping operation 986 may receive the DRB from the PDCP layer 976. Further, the QoS flow mapping operation 986 may map the DRBs to QoS flows. The QoS flow mapping operation 986 may map the DRBs in accordance with the mappings defined in the UL.

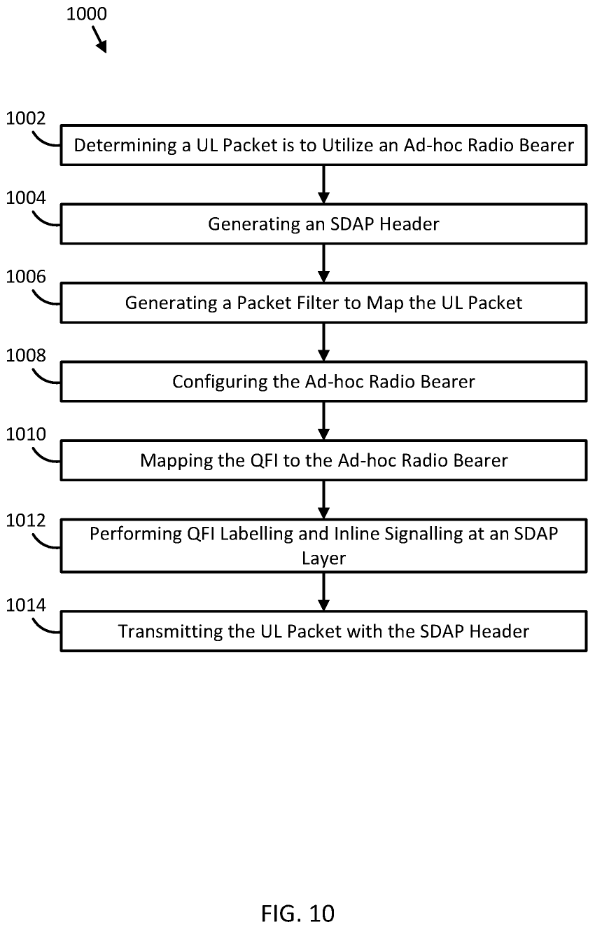

FIG. 10 illustrates an example procedure 1000 for implementing UL reflective QoS in accordance with some embodiments. The procedure 1000 may be performed by a UE (such as the UE 402 (FIG. 4) and/or the UE 1400 (FIG. 14)).

The procedure 1000 may include determining a UL packet is to utilize an ad-hoc radio bearer in 1002. For example, the UE may determine a UL packet to be transmitted to a base station is to utilize an ad-hoc radio bearer. The UE may determine that the UL packet is to utilize the ad-hoc radio bearer based on the configuration considerations in some embodiments.

The procedure 1000 may include generating an SDAP header in 1004. For example, the UE may generate a SDAP header that includes an RDI to indicate whether a QoS flow to DRB rule is to be updated and an RQI to indicate whether DL packets are to be mapped to QFIs based on the UL packet. In some embodiments, the SDAP header may include one or more of the features of the header of the UL SDAP data PDU 300 (FIG. 3). In some embodiments, the SDAP header may include a QFI corresponding to the ad-hoc radio bearer.

In some embodiments, the SDAP header includes a context ID to indicate an establishment of the ad-hoc radio bearer in accordance with preconfigured DRB settings corresponding to the context ID. In some of these embodiments, the preconfigured DRB settings may be first preconfigured DRB settings. The SDAP header may further include an extension flag to indicate whether the SDAP header includes an additional context ID to indicate second preconfigured DRB settings for configuration of an additional ad-hoc radio bearer.

The procedure 1000 may include generating a packet filter to map the UL packet in 1006. For example, the UE may generate a packet filter to map the UL packet to a different QFI. The packet filter may be implemented as part of a QoS flow mapping operation (such as the QoS flow mapping operation 908 (FIG. 9)). In some embodiments, 1006 may be omitted.

The procedure 1000 may include configuring the ad-hoc radio bearer in 1008. For example, the UE may configure the ad-hoc radio bearer. The UE may configure the ad-hoc radio bearer based on configuration considerations for the ad-hoc radio bearer. In some embodiments, 1008 may be omitted.

The procedure 1000 may include mapping the QFI to the ad-hoc radio bearer in 1010. For example, the UE may map the QFI to the ad-hoc radio bearer configured in 1008. In some embodiments, 1010 may be omitted.

The procedure 1000 may include performing QFI labelling and inline signalling at an SDAP layer in 1012. For example, the UE may perform QFI labelling and inline signalling at an SDAP layer (such as the SDAP layer 930 (FIG. 9)) located between a MAC layer and an RLC layer. In some embodiments, 1012 may be omitted.

The procedure 1000 may include transmitting the UL packet with the SDAP header in 1014. For example, the UE may transmit the UL packet with the SDAP to the base station.

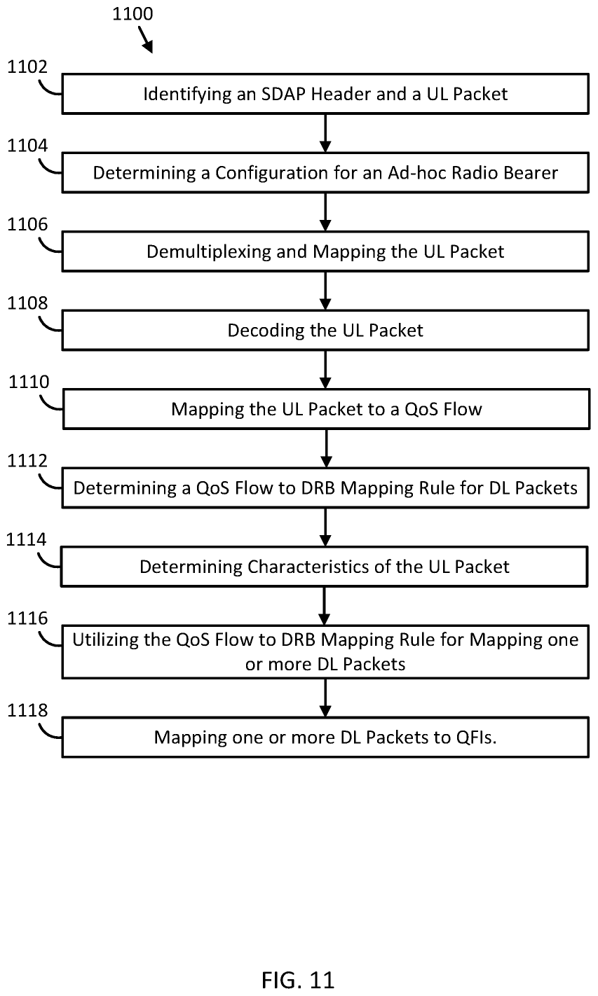

FIG. 11 illustrates an example procedure 1100 for implementing UL reflective QoS in accordance with some embodiments. The procedure 1100 may be performed by a base station (such as the base station 404 (FIG. 4) and/or the gNB 1500 (FIG. 15)).

The procedure 1100 may include identifying an SDAP header and a UL packet 1102. For example, the base station may identify an SDAP header and a UL packet received from a UE. In some embodiments, the SDAP header and the UL packet are received in a transport block.

The SDAP header may include an RDI in some embodiments. In some embodiments, the SDAP header may include an RQI. Further, the SDAP header may include a context ID in some embodiments.

The procedure 1100 may include determining a configuration for an ad-hoc radio bearer in 1104. For example, the base station may determine a configuration for an ad-hoc radio bearer of the UL packet based on the SDAP header. In some embodiments, determining the configuration may include determining preconfigured DRB settings corresponding to the context ID from the SDAP header.

The procedure 1100 may include demultiplexing and mapping the UL packet in 1106. For example, the base station may demultiplex and map the UL packet according to the ad-hoc radio bearer at an SDAP layer (such as the SDAP layer 956 (FIG. 9)) located between a MAC layer and an RLC layer. In some embodiments, demultiplexing and mapping the UL packet may include mapping the UL packet based on the RDI from the SDAP header.

The procedure 1100 may include decoding the UL packet in 1108. For example, the base station may decode the UL packet based on the configuration for the ad-hoc radio bearer.

The procedure 1100 may include mapping the UL packet to QoS flow in 1110. For example, the base station may map the UL packet to a QoS flow based on the RQI. In some embodiments, 1110 may be omitted.

The procedure 1100 may include determining a QoS flow to DRB mapping rule for DL packets in 1112. For example, the base station may determine a QoS flow to DRB mapping rule for DL packets based on a mapping defined by the UL packet. In some embodiments, 1112 may be omitted.

The procedure 1100 may include determining characteristics of the UL packet in 1114. For example, the base station may determine characteristics of the UL packet. In some embodiments, 1114 may be omitted.

The procedure 1100 may include utilizing the QoS flow to DRB mapping rule for mapping one or more DL packets in 1116. For example, the base station may utilize the QoS flow to DRB mapping rule determined in 1112 for mapping one or more DL packets. In some embodiments, 1116 may be omitted.

The procedure 1100 may include mapping one or more DL packets to QFIs in 1118. For example, the base station may map one or more DL packets to QFIs based on the characteristics of the UL packet determined in 1114.

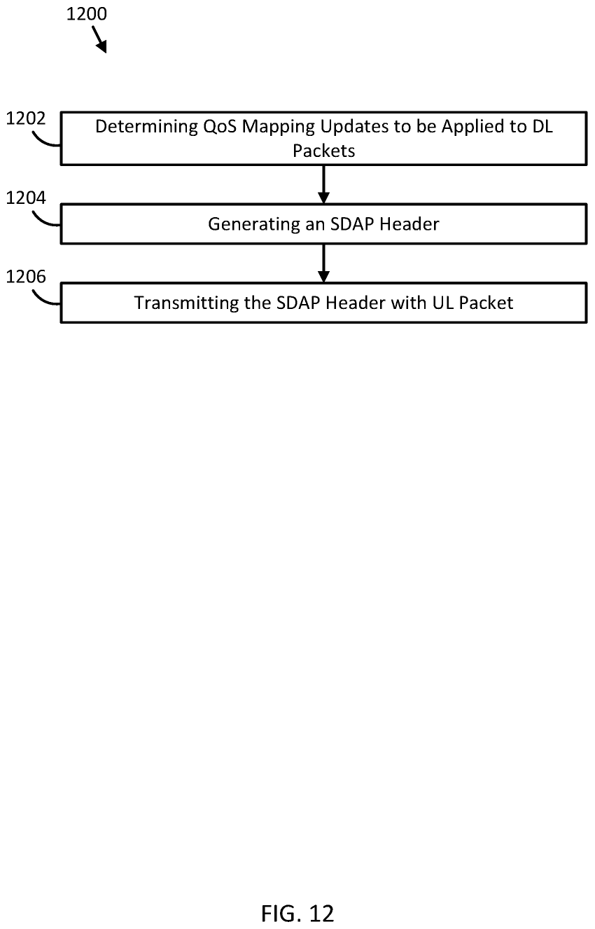

FIG. 12 illustrates an example procedure 1200 for implementing UL reflective QoS in accordance with some embodiments. The procedure 1200 may be performed by a UE (such as the UE 402 (FIG. 4) and/or the UE 1400 (FIG. 14)).

The procedure 1200 may include determining QoS mapping updates to be applied to DL packets in 1202. For example, the UE may determine QoS mapping updates to be applied to DL packets to be received from a base station. The QoS mapping updates may include an update to be made to a QoS flow to DRB rule in some embodiments. Further, the QoS mapping updates may include an update to be made to DL packets mapping to QoS flow identifiers (QFIs) in some embodiments.

The procedure 1200 may include generating an SDAP header in 1204. For example, the UE may generate an SDAP header that indicates the QoS mapping updates for the DL packets. The SDAP header may include one or more of the features of the header of the UL SDAP data PDU 500 (FIG. 5) or the header of the UL SDAP data PDU 600 (FIG. 6) in some embodiments. In some embodiments, the SDAP header may include an RDI that indicates that the QoS flow to DRB rule is to be updated. Further, the SDAP header may include a RQI that indicates that the DL packets mapping to QFIs is to be updated in some embodiments. In some embodiments, the SDAP header may include a QFI to indicate a QoS flow for a UL packet to be transmitted with the SDAP header.

The procedure 1200 may include transmitting the SDAP header with the UL packet in 1206. For example, the UE may transmit the SDAP header with the UL packet to the base station to indicate the QoS mapping updates to be applied. In some embodiments, the SDAP header may be applied to the UL packet in an SDAP layer located between a MAC layer and an RLC layer.

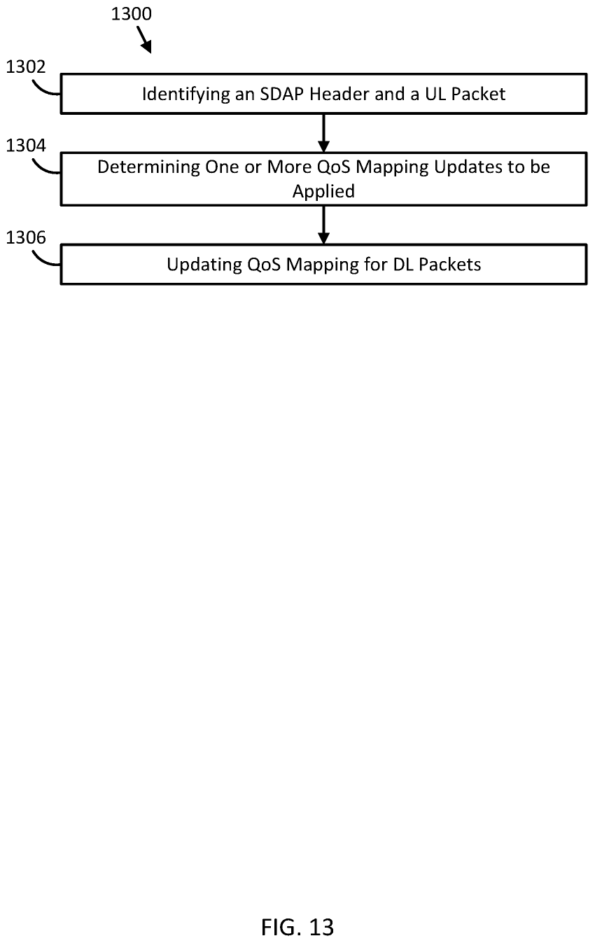

FIG. 13 illustrates an example procedure 1300 for implementing UL reflective QoS in accordance with some embodiments. The procedure 1300 may be performed by a base station (such as the base station 404 (FIG. 4) and/or the gNB 1500 (FIG. 15)).

The procedure 1300 may include identifying an SDAP header and a UL packet in 1302. For example, the base station may identify an SDAP header and a UL packet received from a UE.

The procedure 1300 may include determining one or more QoS mapping updates to be applied in 1304. For example, the base station may determine one or more QoS mapping updates to be applied to DL packets from the SDAP header. In some embodiments, determining the one or more QoS mapping updates may include determining that the SDAP header includes an RDI that indicates that a QoS flow to DRB rule is to be updated. Further, determining the one or more QoS mapping updates may include determining that the SDAP header includes an RQI that indicates that DL packets mapping to QoS flow identifiers is to be updated in some embodiments. In some embodiments, determining the one or more QoS mapping updates may include determining that the SDAP header includes a QFI.

The procedure 1300 may include updating QoS mapping for DL packets in 1306. For example, the base station may update QoS mapping for the DL packets based on the one or more QoS mapping updates. In some embodiments, updating the QoS mapping may include updating the QoS flow to DRB rule based on a mapping defined in the UL packet. Further, updating the QoS mapping may include updating the DL packets mapping to QFI based on characteristics of the UL packet in some embodiments. In some embodiments, updating the QoS mapping includes mapping the UL packet based on the QFI.

FIG. 14 illustrates an example UE 1400 in accordance with some embodiments. The UE 1400 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1400 may be a RedCap UE or NR-Light UE.

The UE 1400 may include processors 1404, RF interface circuitry 1408, memory/storage 1412, user interface 1416, sensors 1420, driver circuitry 1422, power management integrated circuit (PMIC) 1424, antenna structure 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangement of the components shown may occur in other implementations.

The components of the UE 1400 may be coupled with various other components over one or more interconnects 1432, which may represent any type of interface, input/output, bus (local, system, or expansion), transmission line, trace, optical connection, etc. that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1412 may include one or more non-transitory, computer-readable media that includes instructions (for example, communication protocol stack 1436) that may be executed by one or more of the processors 1404 to cause the UE 1400 to perform various operations described herein. The memory/storage 1412 include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1408 may include transceiver circuitry and radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1426.

In various embodiments, the RF interface circuitry 1408 may be configured to transmit/receive signals in a manner compatible with NR access technologies.

The antenna 1426 may include antenna elements to convert electrical signals into radio waves to travel through the air and to convert received radio waves into electrical signals. The antenna elements may be arranged into one or more antenna panels. The antenna 1426 may have antenna panels that are omnidirectional, directional, or a combination thereof to enable beamforming and multiple input, multiple output communications. The antenna 1426 may include microstrip antennas, printed antennas fabricated on the surface of one or more printed circuit boards, patch antennas, phased array antennas, etc. The antenna 1426 may have one or more panels designed for specific frequency bands including bands in FR1 or FR2.

The user interface circuitry 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensor circuitry 1420 and control and allow access to sensor circuitry 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1400 may power down for brief intervals of time and thus save power. If there is no data traffic activity for an extended period of time, then the UE 1400 may transition off to an RRC_Idle state, where it disconnects from the network and does not perform operations such as channel quality feedback, handover, etc. The UE 1400 goes into a very low power state and it performs paging where again it periodically wakes up to listen to the network and then powers down again. The UE 1400 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1428 may power the UE 1400, although in some examples the UE 1400 may be mounted deployed in a fixed location, and may have a power supply coupled to an electrical grid. The battery 1428 may be a lithium ion battery, a metal-air battery, such as a zinc-air battery, an aluminum-air battery, a lithium-air battery, and the like. In some implementations, such as in vehicle-based applications, the battery 1428 may be a typical lead-acid automotive battery.

FIG. 15 illustrates an example gNB 1500 in accordance with some embodiments. The gNB 1500 may include processors 1504, RF interface circuitry 1508, core network (CN) interface circuitry 1512, memory/storage circuitry 1516, and antenna structure 1526.

The components of the gNB 1500 may be coupled with various other components over one or more interconnects 1528.

The processors 1504, RF interface circuitry 1508, memory/storage circuitry 1516 (including communication protocol stack 1510), antenna structure 1526, and interconnects 1528 may be similar to like-named elements shown and described with respect to FIG. 14.

The CN interface circuitry 1512 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 may include a method of operating a user equipment (UE), comprising determining an uplink (UL) packet to be transmitted to a base station is to utilize an ad-hoc radio bearer, generating a service data adaptation protocol (SDAP) header that includes a reflective quality of service flow to data radio bearer mapping indication (RDI) to indicate whether a quality of service (QoS) flow to data radio bearer (DRB) rule is to be updated and a reflective quality of service flow indicator (RQI) to indicate whether downlink (DL) packets are to be mapped to quality of service flow identifiers (QFIs) based on the UL packet, and transmitting the UL packet with the SDAP header to the base station.

Example 2 may include the method of example 1, further comprising generating a packet filter to map the UL packet to a different quality of service flow identifier (QFI), configuring the ad-hoc radio bearer, and mapping the QFI to the ad-hoc radio bearer.

Example 3 may include the method of example 1, wherein the SDAP header further includes a context identifier (ID) to indicate an establishment of the ad-hoc radio bearer in accordance with preconfigured DRB settings corresponding to the context ID.

Example 4 may include the method of example 3, wherein the preconfigured DRB settings are first preconfigured DRB settings, wherein the SDAP header further includes an extension flag to indicate whether the SDAP header includes an additional context ID to indicate second preconfigured DRB settings for configuration of an additional ad-hoc radio bearer.

Example 5 may include the method of example 1, wherein the SDAP header further includes a quality of service flow identifier (QFI) corresponding to the ad-hoc radio bearer.

Example 6 may include the method of example 1, further comprising performing QFI labelling and inline signalling at an SDAP layer located between a medium access control (MAC) layer and a radio link control (RLC) layer.

Example 7 may include the method of example 1, wherein the SDAP header is applied to the UL packet via an SDAP layer located between a medium access control (MAC) layer of the UE and a radio link control (RLC) layer of the UE.

Example 8 may include the method of example 1, wherein the SDAP header further includes a data/control field that indicates whether the UL packet is to be transmitted in a data transmission or a control transmission, and wherein transmitting the UL packet comprises transmitting the UL packet in the data transmission or the control transmission in accordance with the data/control field.

Example 9 may include a method of operating a base station, comprising identifying a service data adaptation protocol (SDAP) header and an uplink (UL) packet received from a user equipment (UE), determining a configuration for an ad-hoc radio bearer of the UL packet based on the SDAP header, demultiplexing and mapping the UL packet according to the ad-hoc radio bearer at an SDAP layer located between a medium access control (MAC) layer and a radio link control (RLC) layer, and decoding the UL packet based on the configuration for the ad-hoc radio bearer.

Example 10 may include the method of example 9, wherein the SDAP header includes a reflective quality of service flow to data radio bearer mapping indication (RDI), wherein demultiplexing and mapping the UL packet includes mapping the UL packet based on the RDI.

Example 11 may include the method of example 9, wherein the SDAP header includes a reflective quality of service flow indicator (RQI), wherein the method further comprises mapping the UL packet to a quality of service (QoS) flow based on the RQI.

Example 12 may include the method of example 9, wherein the SDAP header includes a context identifier (ID), wherein determining the configuration for the ad-hoc radio bearer includes determining preconfigured data radio bearer (DRB) settings corresponding to the context ID.

Example 13 may include the method of example 9, further comprising determining a QoS flow to DRB mapping rule for DL packets based on a mapping defined by the UL packet, and utilizing the QoS flow to DRB mapping rule for mapping of one or more DL packets.

Example 14 may include the method of example 9, further comprising determining characteristics of the UL packet, and mapping one or more DL packets to QFIs based on the characteristics of the UL packet.

Example 15 may include the method of example 9, wherein the SDAP header and the UL packet are received in a transport block.

Example 16 may include a method of operating a user equipment (UE), comprising determining quality of service (QoS) mapping updates to be applied to downlink (DL) packets to be received from a base station, generating a service data adaptation protocol (SDAP) header that indicates the QoS mapping updates for the DL packets, and transmitting the SDAP header with an uplink (UL) packet to the base station to indicate the QoS mapping updates to be applied.

Example 17 may include the method of example 16, wherein the QoS mapping updates includes an update to be made to a QoS flow to data radio bearer (DRB) rule, and wherein the SDAP header includes a reflective quality of service flow to data radio bearer mapping indication (RDI) that indicates that the QoS flow to DRB rule is to be updated.

Example 18 may include the method of example 16, wherein the QoS mapping updates includes an update to be made to DL packets mapping to QoS flow identifiers (QFIs), and wherein the SDAP header includes a reflective quality of service flow indicator (RQI) that indicates that the DL packets mapping to QFIs is to be updated.

Example 19 may include the method of example 16, wherein the SDAP header includes a QoS flow identifier (QFI) to indicate a QoS flow for the UL packet.

Example 20 may include the method of example 16, wherein the SDAP header is applied to the UL packet in an SDAP layer located between a medium access control (MAC) layer and a radio link control (RLC) layer.

Example 21 may include a method of operating a base station, comprising identifying a service data adaptation protocol (SDAP) header and an uplink (UL) packet received from a user equipment (UE), determining one or more quality of service (QoS) mapping updates to be applied to downlink (DL) packets from the SDAP header, and updating QoS mapping for the DL packets based on the one or more QoS mapping updates.

Example 22 may include the method of example 21, wherein determining the one or more QoS mapping updates includes determining that the SDAP header includes a reflective QoS flow to data radio bearer mapping indication (RDI) that indicates that a QoS flow to DRB rule is to be updated, and wherein updating the QoS mapping includes updating the QoS flow to DRB rule based on a mapping defined in the UL packet.

Example 23 may include the method of example 21, wherein determining the one or more QoS mapping updates includes determining that the SDAP header includes a reflective QoS flow indicator (RQI) that indicates that DL packets mapping to QoS flow identifiers QFIs is to be updated, and wherein updating the QoS mapping includes updating the DL packets mapping to QFIs based on characteristics of the UL packet.

Example 24 may include the method of example 21, wherein determining the one or more QoS mapping updates includes determining that the SDAP header includes a QoS flow identifier (QFI), and wherein updating the QoS mapping includes mapping the UL packet based on the QFI.

Example 25 may include an apparatus comprising means to perform one or more elements of a method described in or related to any of examples 1-24, or any other method or process described herein.

Example 26 may include one or more non-transitory computer-readable media comprising instructions to cause an electronic device, upon execution of the instructions by one or more processors of the electronic device, to perform one or more elements of a method described in or related to any of examples 1-24, or any other method or process described herein.

Example 27 may include an apparatus comprising logic, modules, or circuitry to perform one or more elements of a method described in or related to any of examples 1-24, or any other method or process described herein.

Example 28 may include a method, technique, or process as described in or related to any of examples 1-24, or portions or parts thereof.

Example 29 may include an apparatus comprising: one or more processors and one or more computer-readable media comprising instructions that, when executed by the one or more processors, cause the one or more processors to perform the method, techniques, or process as described in or related to any of examples 1-24, or portions thereof.

Example 30 may include a signal as described in or related to any of examples 1-24, or portions or parts thereof.

Example 31 may include a datagram, information element, packet, frame, segment, PDU, or message as described in or related to any of examples 1-24, or portions or parts thereof, or otherwise described in the present disclosure.

Example 32 may include a signal encoded with data as described in or related to any of examples 1-24, or portions or parts thereof, or otherwise described in the present disclosure.

Example 33 may include a signal encoded with a datagram, IE, packet, frame, segment, PDU, or message as described in or related to any of examples 1-24, or portions or parts thereof, or otherwise described in the present disclosure.

Example 34 may include an electromagnetic signal carrying computer-readable instructions, wherein execution of the computer-readable instructions by one or more processors is to cause the one or more processors to perform the method, techniques, or process as described in or related to any of examples 1-24, or portions thereof.

Example 35 may include a computer program comprising instructions, wherein execution of the program by a processing element is to cause the processing element to carry out the method, techniques, or process as described in or related to any of examples 1-24, or portions thereof.

Example 36 may include a signal in a wireless network as shown and described herein.

Example 37 may include a method of communicating in a wireless network as shown and described herein.

Example 38 may include a system for providing wireless communication as shown and described herein.

Example 39 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory computer-readable media having instructions that, when executed by one or more processors, cause a user equipment (UE) to:
determine an uplink (UL) packet to be transmitted to a base station is to utilize an ad-hoc radio bearer;
generate a service data adaptation protocol (SDAP) header that includes a reflective quality of service flow to data radio bearer mapping indication (RDI) to indicate whether a quality of service (QoS) flow to data radio bearer (DRB) rule is to be updated and a reflective quality of service flow indicator (RQI) to indicate whether downlink (DL) packets are to be mapped to quality of service flow identifiers (QFIs) based on the UL packet; and
transmit the UL packet with the SDAP header to the base station.

2. The one or more non-transitory computer-readable media of claim 1, wherein the instructions, when executed by the one or more processors, further cause the UE to:
generate a packet filter to map the UL packet to a different quality of service flow identifier (QFI);
configure the ad-hoc radio bearer; and
map the QFI to the ad-hoc radio bearer.

3. The one or more non-transitory computer-readable media of claim 1, wherein the SDAP header further includes a context identifier (ID) to indicate an establishment of the ad-hoc radio bearer in accordance with preconfigured DRB settings corresponding to the context ID.

4. The one or more non-transitory computer-readable media of claim 3, wherein the preconfigured DRB settings are first preconfigured DRB settings, wherein the SDAP header further includes an extension flag to indicate whether the SDAP header includes an additional context ID to indicate second preconfigured DRB settings for configuration of an additional ad-hoc radio bearer.

5. The one or more non-transitory computer-readable media of claim 1, wherein the SDAP header further includes a quality of service flow identifier (QFI) corresponding to the ad-hoc radio bearer.

6. The one or more non-transitory computer-readable media of claim 1, wherein the instructions, when executed by the one or more processors, further cause the UE to:
perform QFI labelling and inline signalling at an SDAP layer located between a medium access control (MAC) layer and a radio link control (RLC) layer.

7. The one or more non-transitory computer-readable media of claim 1, wherein the SDAP header is applied to the UL packet via an SDAP layer located between a medium access control (MAC) layer of the UE and a radio link control (RLC) layer of the UE.

8. The one or more non-transitory computer-readable media of claim 1, wherein the SDAP header further includes a data/control field that indicates whether the UL packet is to be transmitted in a data transmission or a control transmission, and wherein to transmit the UL packet comprises to transmit the UL packet in the data transmission or the control transmission in accordance with the data/control field.

9. A method of operating a base station, comprising:
identifying a service data adaptation protocol (SDAP) header and an uplink (UL) packet received from a user equipment (UE);
determining a configuration for an ad-hoc radio bearer of the UL packet based on the SDAP header;
demultiplexing and mapping the UL packet according to the ad-hoc radio bearer at an SDAP layer located between a medium access control (MAC) layer and a radio link control (RLC) layer; and
decoding the UL packet based on the configuration for the ad-hoc radio bearer.

10. The method of claim 9, wherein the SDAP header includes a reflective quality of service flow to data radio bearer mapping indication (RDI), wherein demultiplexing and mapping the UL packet includes mapping the UL packet based on the RDI.

11. The method of claim 9, wherein the SDAP header includes a reflective quality of service flow indicator (RQI), wherein the method further comprises:
mapping the UL packet to a quality of service (QoS) flow based on the RQI.

12. The method of claim 9, wherein the SDAP header includes a context identifier (ID), wherein determining the configuration for the ad-hoc radio bearer includes determining preconfigured data radio bearer (DRB) settings corresponding to the context ID.

13. The method of claim 9, further comprising:
determining a QoS flow to DRB mapping rule for DL packets based on a mapping defined by the UL packet; and
utilizing the QoS flow to DRB mapping rule for mapping of one or more DL packets.

14. The method of claim 9, further comprising:
determining characteristics of the UL packet; and
mapping one or more DL packets to QFIs based on the characteristics of the UL packet.

15. The method of claim 9, wherein the SDAP header and the UL packet are received in a transport block.

16. A user equipment (UE), comprising:
memory to store a service data adaptation protocol (SDAP) header; and
one or more processors coupled to the memory, the one or more processors to:
determine quality of service (QoS) mapping updates to be applied to downlink (DL) packets to be received from a base station;
generate the SDAP header that indicates the QoS mapping updates for the DL packets; and
transmit the SDAP header with an uplink (UL) packet to the base station to indicate the QoS mapping updates to be applied.

17. The UE of claim 16, wherein the QoS mapping updates includes an update to be made to a QoS flow to data radio bearer (DRB) rule, and wherein the SDAP header includes a reflective quality of service flow to data radio bearer mapping indication (RDI) that indicates that the QoS flow to DRB rule is to be updated.

18. The UE of claim 16, wherein the QoS mapping updates includes an update to be made to DL packets mapping to QoS flow identifiers (QFIs), and wherein the SDAP header includes a reflective quality of service flow indicator (RQI) that indicates that the DL packets mapping to QFIs is to be updated.

19. The UE of claim 16, wherein the SDAP header includes a QoS flow identifier (QFI) to indicate a QoS flow for the UL packet.

20. The UE of claim 16, wherein the SDAP header is applied to the UL packet in an SDAP layer located between a medium access control (MAC) layer and a radio link control (RLC) layer.
